(19) United States
(12) Patent Application Publication
(10) Pub. No.: US 2006/0167954 A1
(43) Pub. Date: Jul. 27, 2006

(54) Information processing method, information processing apparatus, method of controlling server apparatus, and server apparatus

(75) Inventors: Masakazu Fujiki, Tokyo (JP); Toshikazu Ohshima, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/547,766

(22) PCT Filed: Feb. 27, 2004
(86) PCT No.: PCT/JP04/02451

§ 371 Date: Sep. 2, 2005

(30) Foreign Application Priority Data
Mar. 3, 2003 (JP) 2003-055596

(51) Int. Cl. G06F 17/30; G06F 15/16

(52) U.S. Cl. 707/201; 707/200; 709/203

(57) ABSTRACT

When a command is a command which requests to establish a communication path with a server apparatus, the communication path with the server apparatus is established (S603), and a sharing mode is set in a public mode (S604). When a command is a command which requests to disconnect the communication path with the server apparatus, the communication path with the server apparatus is disconnected (S606), and the sharing mode is set in a private mode (S607). When a command is a database manipulation command, an event indicating the contents of the manipulation command is generated (S608). If the sharing mode is a public mode, the event is input to a transceiver queue (S610). If the sharing mode is a private mode, the event is input to a receiver queue (409) (S611).

### TECHNICAL FIELD

The present invention relates to a technique for handling data.

### BACKGROUND ART

A technique for sharing a three-dimensional virtual space among different computer terminals is indispensable to implement remote meeting systems, network games, cooperative design systems, and the like.

As an implementation example of such virtual space sharing system, Distributed Open Inventor (source: G. Heshina et. al.: “Distributed Open Inventor: A Practical Approach to Distributed 3D Graphics”, in Proc. of the ACM Symposium on Virtual Reality Software and Technology (VRST'99), pp. 74-81, 1999) is known.

For example, in a conventional virtual space sharing system, when shared data is changed at a given terminal, the change contents are transmitted to other terminals connected via a network, and these terminals change data based on the received change contents, thus maintaining data consistency among the terminals.

Data held by respective terminals can be set in a state wherein they are shared among programs which run on these terminals, or in a state wherein they are not shared among them. The sharing/non-sharing state can be switched for each object called a “node” which forms virtual space data.

However, in the aforementioned virtual space sharing system, the structure of virtual space data must be changed to switch the data sharing/non-sharing state. Also, the above system cannot switch the sharing/non-sharing state for each program or for each property of an object.

Furthermore, when an arbitrary computer terminal changes shared data before all computer terminals that share a virtual space establish connection to a network, a computer terminal which is not connected to the network cannot receive information associated with that change, and data inconsistency occurs among programs which run on the respective terminals.

The present invention has been made in consideration of the above problems, and has as its object to provide a technique that makes a data sharing system to be a flexible and consistent system.

### DISCLOSURE OF INVENTION

In order to achieve the above object, for example, an information processing method of the present invention comprises the following arrangement.

That is, an information processing method to be executed by an information processing apparatus which can communicate with a self apparatus and other apparatuses via a server apparatus, and comprises first holding unit adapted to hold data indicating contents of a command transmitted from the information processing apparatus to the server apparatus, and second holding unit adapted to hold data indicating contents of a command to be processed in the selfapparatus, characterized by comprising:

an interpretation step of interpreting an input command;

a control step of establishing or disconnecting, when it is determined as a result of interpretation in the interpretation step that the input command is a command that requests to establish or disconnect a communication path with the server apparatus, the communication path in accordance with the input command; and

an output step of generating, when it is determined as a result of interpretation in the interpretation step that the input command is a command that requests to manipulate a predetermined database, data indicating the input command, and outputting the generated data to one of the first and second holding units depending on whether the communication path is established or disconnected in the control step.

In order to achieve the above object, for example, an information processing method of the present invention comprises the following arrangement.

That is, an information processing method having a first mode for outputting information to other processes with which communications can be made, and a second mode for outputting information to a self process, characterized by comprising:

a generation step of generating manipulation request information indicating a manipulation request to data;

a transmission step of inputting the generated request information to a transceiver queue, and transmitting the request information to other processes;

a reception step of receiving manipulation request information generated by the other processes, and inputting the received request information to a receiver queue; and

a manipulation execution step of executing a data manipulation in accordance with the manipulation request information input to the receiver queue, and

in that when the first mode is set, the manipulation request information generated in the generation step is input to the transceiver queue and is transmitted to the other processes in the transmission step, and

when the second mode is set, the manipulation request information generated in the generation step is input to the receiver queue, and a data manipulation is executed in the manipulation execution step in accordance with the manipulation request information input to the receiver queue.

In order to achieve the above object, for example, a method of controlling a server apparatus of the present invention comprises the following arrangement.

That is, a method of controlling a server apparatus which can communicate with a plurality of client terminals via a network, characterized by comprising:

a reception step of receiving data of a command from at least one client terminal via the network;

a count step of counting the number of client terminals which establish a communication path with the server apparatus via the network; and

a transmission step of transmitting, when the count result in the count step is not less than a predetermined value, the data received in the reception step to the plurality of client terminals.

In order to achieve the above object, for example, an information processing apparatus of the present invention comprises the following arrangement.

That is, an information processing apparatus which can communicate with a self apparatus and other apparatuses via a server apparatus, characterized by comprising:

first holding unit adapted to hold data indicating contents of a command transmitted from the information processing apparatus to the server apparatus;

second holding unit adapted to hold data indicating contents of a command to be processed in the selfapparatus;

interpretation unit adapted to interpret an input command;

control unit adapted to, when it is determined as a result of interpretation by the interpretation unit that the input command is a command that requests to establish or disconnect a communication path with the server apparatus, establish or disconnect the communication path in accordance with the input command; and

output unit adapted to, when it is determined as a result of interpretation by the interpretation unit that the input command is a command that requests to manipulate a predetermined database, generate data indicating the input command, and output the generated data to one of the first and second holding units depending on whether the communication path is established or disconnected by the control unit.

In order to achieve the above object, for example, an information processing apparatus of the present invention comprises the following arrangement.

That is, an information processing apparatus having a first mode for outputting information to other processes with which communications can be made, and a second mode for outputting information to a self process, characterized by comprising:

generation unit adapted to generate manipulation request information indicating a manipulation request to data;

transceiver unit adapted to input the generated request information to a transceiver queue, and transmit the request information to other processes;

receiver unit adapted to receive manipulation request information generated by the other processes, and input the received request information to a receiver queue; and

manipulation execution unit adapted to execute a data manipulation in accordance with the manipulation request information input to the receiver queue, and

in that when the first mode is set, the transceiver unit inputs the manipulation request information generated by the generation unit to the transceiver queue and transmits the request information to the other processes, and

when the second mode is set, the manipulation request information generated by the generation unit is input to the receiver queue, and the manipulation execution unit executes a data manipulation in accordance with the manipulation request information input to the receiver queue.

In order to achieve the above object, for example, a server apparatus of the present invention comprises the following arrangement.

That is, a server apparatus which can communicate with a plurality of client terminals via a network, characterized by comprising:

receiver unit adapted to receive data of a command from at least one client terminal via the network;

count unit adapted to count the number of client terminals which establish a communication path with the server apparatus via the network; and

transceiver unit adapted to, when the count result in the count unit is not less than a predetermined value, transmit the data received by the receiver unit to the plurality of client terminals.

In order to achieve the above object, for example, a program of the present invention comprises the following arrangement.

That is, a program characterized by making a computer, which can communicate with a self apparatus and other apparatuses via a server apparatus, and comprises first holding unit adapted to hold data indicating contents of a command transmitted from the information processing apparatus to the server apparatus, and second holding unit adapted to hold data indicating contents of a command to be processed in the selfapparatus, execute an information processing method of any one of claims 1 to 9.

In order to achieve the above object, for example, a program of the present invention comprises the following arrangement.

That is, a program characterized by making a computer, which can communicate with a self apparatus and other apparatuses via a server apparatus, and comprises first holding unit adapted to hold data indicating contents of a command transmitted from the information processing apparatus to the server apparatus, and second holding unit adapted to hold data indicating contents of a command to be processed in the self apparatus, execute an information processing method of any one of claims 10 to 13.

Other features and advantages of the present invention will be apparent from the following description taken in conjunction with the accompanying drawings, in which like reference characters designate the same or similar parts throughout the figures thereof.

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 is a schematic diagram showing the arrangement of a virtual space sharing system according to the first embodiment of the present invention;

FIG. 2 shows the basic information flow upon updating databases in the system according to the first embodiment of the present invention;

FIG. 3 is a block diagram showing the basic arrangement of a server apparatus and client terminal;

FIG. 4 is a diagram of processes implemented in the client terminal;

FIG. 5 is a flow chart of a main process to be executed by the client terminal according to the first embodiment of the present invention;

FIG. 6 is a flow chart showing details of the process in step S505;

FIG. 7 is a flow chart showing details of the process in step S506;

FIG. 8 is a flow chart showing details of the process in step S503;

FIG. 9 is a flow chart showing details of the process in step S504;

FIG. 10 is a flow chart of a main process to be executed by the server apparatus according to the first embodiment of the present invention;

FIG. 11 is a diagram of processes implemented in a client terminal according to the second embodiment of the present invention;

FIG. 12 shows a file format of data with N entries;

FIG. 13 shows an example of a window displayed on a display unit 309 of a client terminal according to the third embodiment of the present invention;

FIG. 14 shows an example of a window displayed on a display unit 309 of a client terminal according to the fifth embodiment of the present invention;

FIG. 15 shows another display example according to the fifth embodiment of the present invention;

FIG. 16 shows a stylus device 1601;

FIG. 17 shows an example of two-dimensional (2D) display;

FIG. 18 shows an example of a window display used to set a sharing mode for each property of an item;

FIG. 19 is a flow chart of a command process according to the third embodiment of the present invention;

FIG. 20 is a flow chart of a main process to be executed by a client terminal according to the seventh embodiment of the present invention;

FIG. 21 is a flow chart of a process as the first example of a command process in step S2005 according to the seventh embodiment of the present invention;

FIG. 22 is a flow chart of a process as the second example of a command process in step S2005 according to the seventh embodiment of the present invention;

FIG. 23 is a flow chart of a main process to be executed by a server apparatus according to the seventh embodiment of the present invention; and

FIG. 24 is a flow chart of a main process to be executed by a server apparatus according to the eighth embodiment of the present invention.

### BEST MODE FOR CARRYING OUT THE INVENTION

Preferred embodiments of the present invention will now be described in detail in accordance with the accompanying drawings.

### First Embodiment

A system according to this embodiment is a virtual space sharing system in which a plurality of terminals share a scene database that describes the structure and properties of a virtual space. A virtual space sharing system according to this embodiment will be described below.

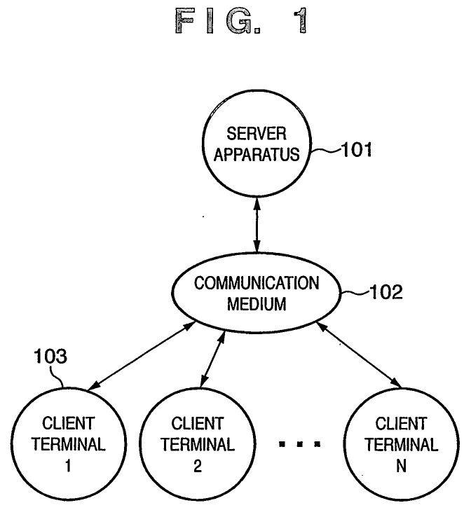

FIG. 1 shows a schematic arrangement of the virtual space sharing system according to this embodiment. The system includes one server apparatus 101 and a plurality of client terminals (client terminals 1 to N in FIG. 1). The server apparatus 101 and client terminals can communicate with each other via a communication medium 102. Each client terminal holds a scene database that describes the structure and properties of a virtual space.

In this embodiment, the communication medium 102 is a LAN built on the Ethernet®. Alternatively, other information transmission media such as USB, Firewire®, and the like may be used. Furthermore, the network is not limited to the LAN, and connections via a WAN may be adopted or both the LAN and WAN may be used in combination.

The term “database manipulation” used in the following description will be explained. A “manipulation” of a database indicates a process for rewriting the contents of a database. The database manipulation is classified into two processes, i.e., “manipulation command” and “manipulation execution”. The manipulation command is an update request of the database, and does not actually rewrite the contents. The actual rewrite process of the database is executed in the manipulation execution process. “Manipulation” will indicate “database manipulation” herein unless otherwise specified. If an object to be manipulated is other than a database, the object to be manipulated is specified like “interactive device manipulation by the user”.

Also, a database manipulation command and network connection state change command will both be referred to as “command”. The network connection state change command includes “connection command” used to establish connection between a client and server, and “disconnection command” used to disconnect that connection.

Note that the manipulation command may be generated by the user or by a process during an operation. As the former example, the manipulation command is generated when the user has moved a virtual object by manipulating an interactive device such as a mouse or the like. On the other hand, as the latter example, the manipulation command is generated when, e.g., a game program has algorithmically moved/rotated an enemy character in a shooting game system.

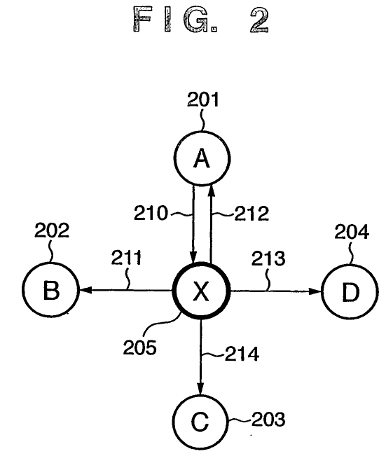

FIG. 2 shows the basic information flow upon updating databases in the system according to this embodiment. In FIG. 2, reference symbols A, B, C, and D denote client terminals; and X, a server apparatus. Assume that client terminal A has generated a manipulation command of a scene database. Data indicating the contents of the manipulation command is transmitted to server apparatus X via a network (data transmission from client terminal apparatus A to server apparatus X is denoted by 210 in FIG. 2).

Upon reception of this manipulation command, server apparatus X distributes data transmitted from client terminal A to all client terminals (A, B, C, D) (data transmission from server apparatus X to all client terminals is denoted by 211, 212, 213, and 214 in FIG. 2).

Through these processes, client terminals B, C, and D can also detect the contents of the manipulation by client terminal A. Note that the manipulation command includes, as its contents, at least information required to specify an object to be manipulated, and information required to specify the type of manipulation. Depending on the types of manipulations, the manipulation command may further include parameters required to implement the manipulation.

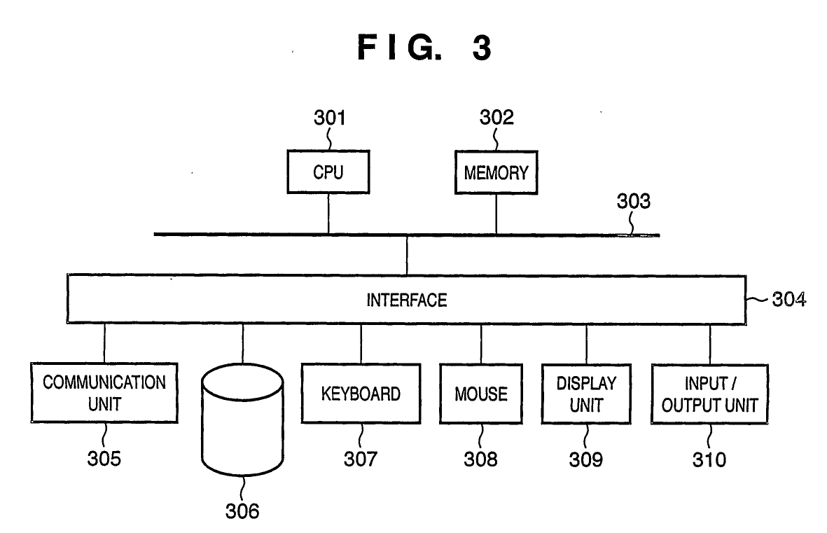

FIG. 3 is a block diagram showing the basic arrangement of the server apparatus and client terminal. Reference numeral 301 denotes a CPU which controls the overall server apparatus or client terminal, and executes process according to a generated command by executing a command input from a keyboard 307 or mouse 308, or a program loaded onto a memory 302.

The memory 302 comprises an area for temporarily holding a program loaded from an external storage device 306 and data including a scene database, and also an area for temporarily holding data used during a process. Furthermore, the memory 302 comprises an area (transceiver buffer) for temporarily holding data to be externally transmitted via a communication unit 305, and an area (receiver buffer) for temporarily holding received data. Reference numeral 303 denotes a bus that interconnects respective units shown in FIG. 3. Reference numeral 304 denotes an interface that interconnects the bus 303 and units to be described below. The communication unit 305 makes data communications with external devices via the communication medium 102.

The external storage device 306 holds programs to be loaded onto the memory 302 and data, and comprises a storage device such as a hard disk or the like. When the arrangement shown in FIG. 3 is that of the server apparatus, the external storage device 306 saves programs corresponding to processes to be executed by the server apparatus (to be described later); when the arrangement shown in FIG. 3 is that of the client terminal, the device 306 saves programs corresponding to processes to be executed by the client terminal (to be described later). These programs are loaded onto the memory 302 as needed, and are processed by the CPU 301. The keyboard 307 and mouse 308 can input various instructions to the CPU 301, and can also input the command.

Reference numeral 309 denotes a display unit which can display the processing result of the CPU 301, and can display, e.g., images on a virtual space shared by the client terminals.

Reference numeral 310 denotes an input/output unit which connects an external apparatus, and inputs/outputs data from/to that apparatus.

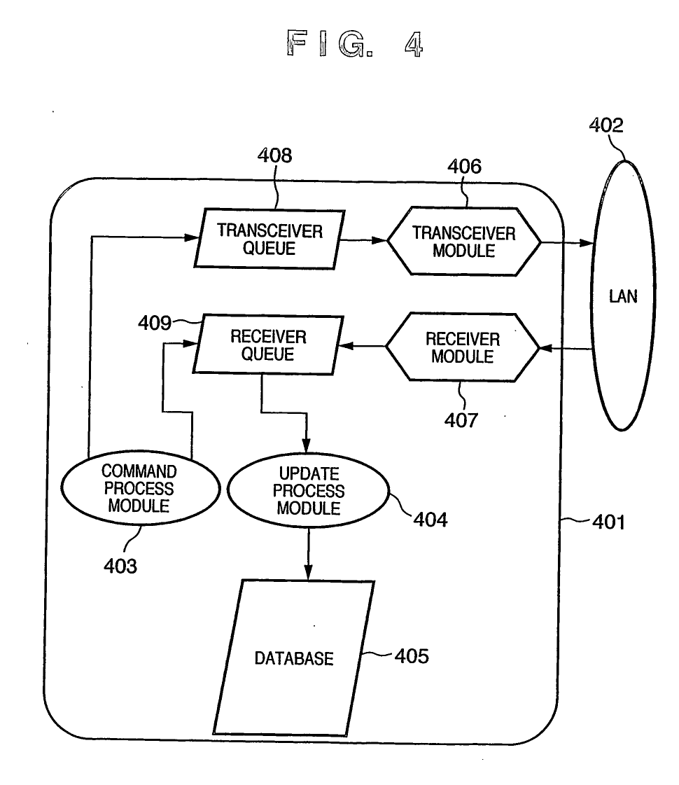

FIG. 4 is a diagram of processes to be implemented in the client terminal. Arrows indicate the flow of data. Reference numeral 401 denotes a client terminal. Processes to be implemented by the client terminal 401 include a command process module 403 for processing a command, and an update process module 404 for updating a database 405 on the basis of the command. Reference numeral 406 denotes a transceiver module for transmitting data onto a LAN 402 as the communication medium 102; and 407, a receiver module for receiving data from the LAN 402. Data are exchanged among these modules via buffers called a transceiver queue 408 and receiver queue 409 (which are assured on the memory 302 in the client terminal). Note that the command process module 403 can input data to the transceiver queue 408 and receiver queue 409.

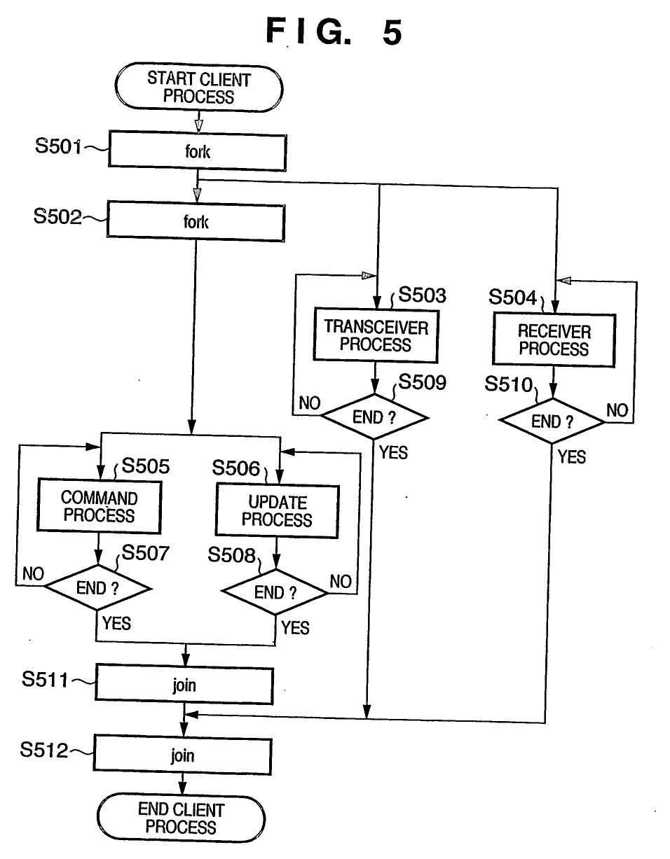

FIG. 5 is a flow chart of a main process to be executed by the client terminal. Note that a program according to the flow chart of FIG. 5 is saved in the external storage device 306, is loaded onto the memory 302 as needed, and is executed by the CPU 301. As a result, the client terminal can implement the process according to the flow chart of FIG. 5.

Upon starting up the client terminal, a process forks (step S501) to execute a transceiver process (step S503) for transmitting data to the server apparatus via the communication medium 102 and a receiver process (step S504) for receiving data from the server apparatus via the communication medium 102. Note that a process for generating a CG image of the virtual space with reference to the scene graph database is also executed (not shown in FIG. 5). Since the process for generating a CG image is the same as the known CG image generation method, a detailed description thereof will be omitted.

Also, the process forks in addition to the above steps (step S502) to execute a command process (step S505) for processing a command, and an update process (step S506) for updating the scene graph database. It is checked in each of steps S509, S510, S507, and S508 if an end instruction of each of the transceiver process, receiver process, command process, and update process is generated. If no end instruction is generated, the flow returns to step S503, S504, S505, or S506 to continue the corresponding process. On the other hand, if an end instruction is generated, the corresponding process ends. Note that the transceiver process, receiver process, command process, and update process will be described in detail later.

A terminology associated with sharing/non-sharing of data will be explained. In the following description, “sharing mode” is used as a term representing whether arbitrary data is set in a sharing or non-sharing state. A state wherein arbitrary data is shared among client terminals is expressed like “the sharing mode of that data is a public mode”. Conversely, a state wherein data is not shared among client terminals is expressed like “the sharing mode is a private mode”. Note that the default value of the sharing mode upon starting up each client terminal is a private mode. Data indicating the sharing mode is held in the memory 302 in the client terminal.

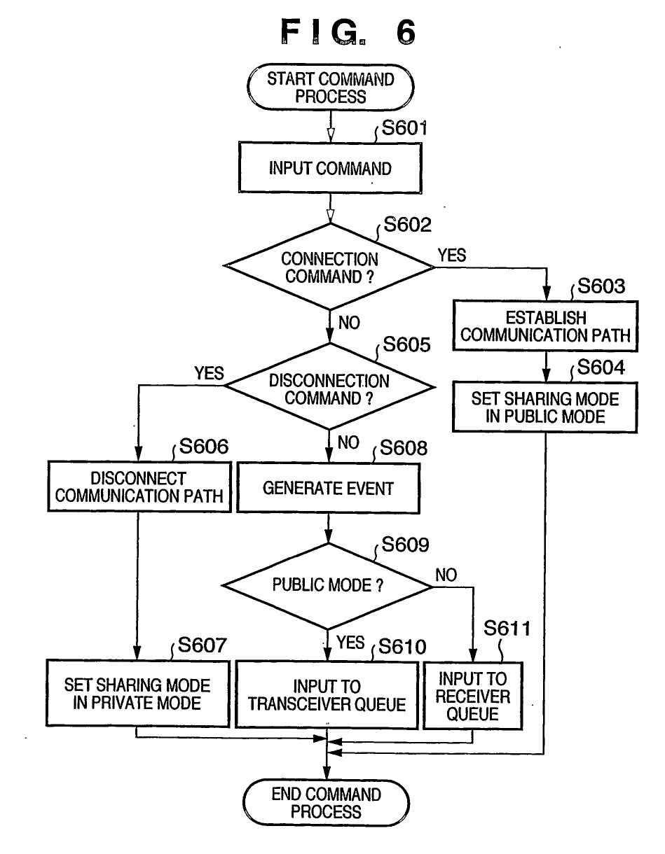

Details of the process in step S505, i.e., the command process for processing a command, will be explained below. FIG. 6 is a flow chart showing details of the process in step S505.

An input command is detected (step S601). Next, the input command is interpreted to determine if this command is a command (connection command) that requests to establish a communication path with the server apparatus via the communication medium 102 (i.e., to connect the server apparatus via the communication medium 102) (step S602). If the input command is a connection command, the flow advances to step S603, and the communication unit 305 establishes a communication path with the server apparatus. The CPU 301 sets a public mode by manipulating data of the sharing mode held in the memory 302 (step S604), thus ending the command process.

On the other hand, if the input command is not a connection command, the flow advances to step S605. In step S605, the command input in step S601 is interpreted to determine if this command is a command (disconnection command) that requests to disconnect the communication path with the server apparatus via the communication medium 102 (i.e., to disconnect from the server apparatus via the communication medium 102) (step S605). If the input command is a disconnection command, the flow advances to step S606, and the communication unit 305 disconnects the communication path with the server apparatus. The CPU 301 then sets a private mode by manipulating data of the sharing mode held in the memory 302 (step S607), thus ending the command process.

On the other hand, if the command input in step S601 is not a disconnection command (i.e., it is neither a connection command nor a disconnection command), it is determined that this command is a database manipulation command, and the flow advances to step S608. In step S608, data called an event which indicates the contents of the manipulation command is generated (step S608).

Next, it is checked with reference to data of the sharing mode held in the memory 302 if the sharing mode is public or private mode (step S609). If the sharing mode is a public mode, the flow advances to step S610 to input the event generated in step S608 to the transceiver queue 408 assured on the memory 302 (step S610), thus ending the command process.

On the other hand, if the sharing mode is a private mode, the flow advances to step S611 to input the event generated in step S608 to the receiver queue 409 assured on the memory 302 (step S611), thus ending the command process.

With the above process, the event can be input to the transceiver queue 408 or receiver queue 409 in correspondence with the public or private mode.

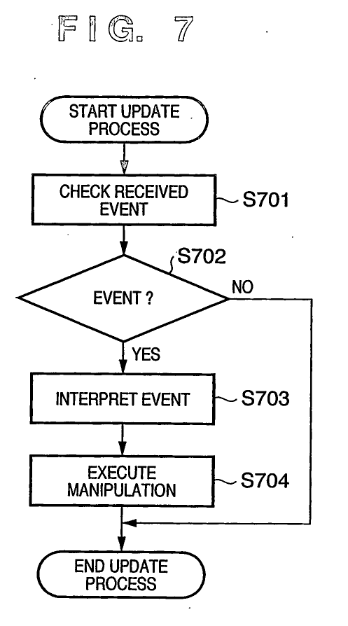

Details of the process in step S506, i.e., the update process for updating the scene graph database will be described below. FIG. 7 is a flow chart showing details of the process in step S506.

The presence/absence of an event in the receiver queue 409 assured on the memory 302 is checked (step S701). If an event is stored in the receiver queue 409, the flow advances from step S702 to step S703, and the event in the receiver queue 409 is acquired and interpreted to extract the contents of a manipulation command (step S703). A manipulation of the scene database is executed in accordance with the interpreted contents of the manipulation command (step S704). On the other hand, if it is determined in step S702 that no event is stored in the receiver queue 409, the update process ends.

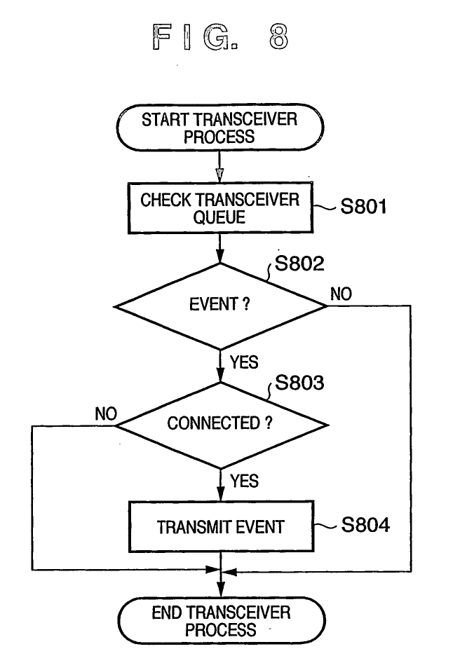

Details of the process in step S503, i.e., the transceiver process for transmitting data to the server apparatus via the communication medium 102 will be described below. FIG. 8 is a flow chart showing details of the process in step S503.

The presence/absence of an event in the transceiver queue 408 assured on the memory 302 is checked (step S801). If an event is stored in the transceiver queue 408, the flow advances from step S802 to step S803 to check if the communication path between the client terminal and server apparatus has been established (step S803). If the communication path has been established, the event in the transceiver queue 408 is transmitted to the server apparatus (step S804). On the other hand, if the communication path is not established, the transceiver process ends.

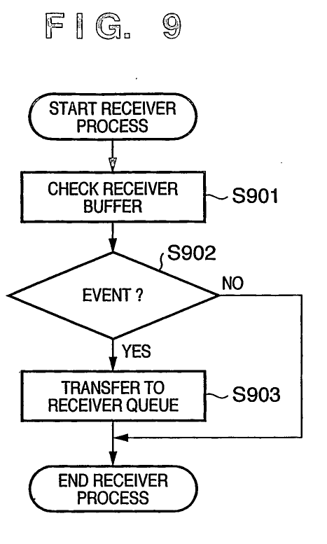

Details of the process in step S504, i.e., the receiver process for receiving data from the server apparatus via the communication medium 102 will be described below. FIG. 9 is a flow chart showing details of the process in step S504.

The presence/absence of an event in the receiver buffer which is assured on the memory 302 and is used to temporarily store event data transmitted from the server apparatus is checked (step S901). If an event is stored in the receiver buffer, the flow advances from step S902 to step S903 to transfer event data in the receiver buffer into the receiver queue 409 (step S903). If no event data is stored in the receiver buffer, the receiver process ends.

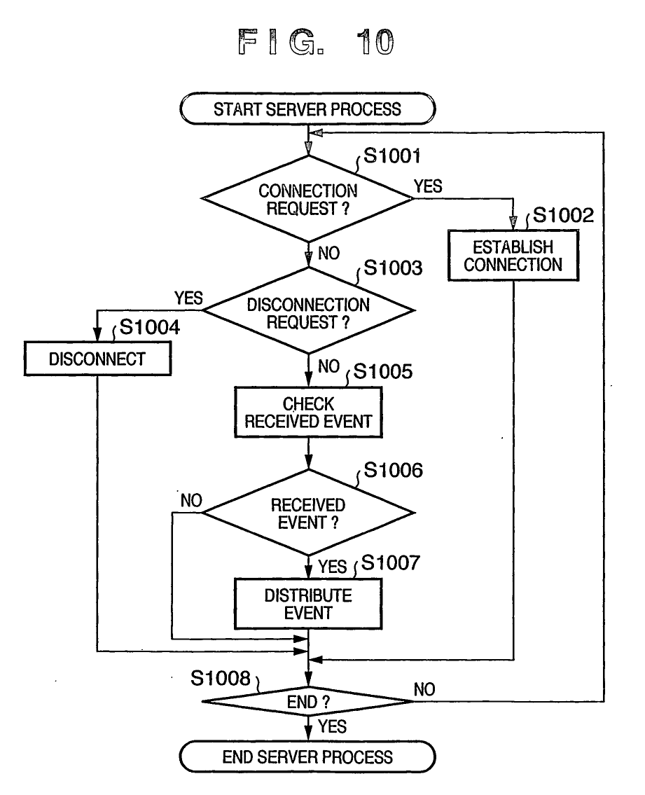

The process to be executed by the server apparatus will be described below. FIG. 10 is a flow chart of a main process to be executed by the server apparatus. Note that a program according to the flow chart of FIG. 10 is saved in the external storage device 306, is loaded onto the memory 302 as needed, and is executed by the CPU 301. As a result, the server apparatus can implement the process according to the flow chart of FIG. 10.

The server apparatus determines whether or not a communication path establishment request is transmitted from a given client terminal (step S1001). If such request is detected, the flow advances to step S1002 to establish the communication path with the client terminal as the request source (step S1002).

If no connection request is detected, the server apparatus determines whether or not a communication path disconnection request is transmitted from the connected client terminal (step S1003). If such request is detected, the flow advances to step S1004 to disconnect the communication path with the client terminal as the request source (step S1004).

If no disconnection request is detected, the flow advances to step S1005 to check the presence/absence of an event received from each client terminal (step S1005). If it is determined that a received event is present (step S1006), the flow advances to step S1007 to distribute that received event to respective client terminals. After that, the flow advances to step S1008.

On the other hand, if no received event is found (step S1006), the flow jumps to step S1008. It is checked in step S1008 if an instruction for ending the program is input. If an end instruction is detected, the above process ends.

If no end instruction is detected, the flow returns to step S1001 to continue the subsequent processes.

As described above, according to the system of this embodiment, whether an event is transmitted from the client terminal to the server or is processed in the client terminal can be determined. As a result, the data sharing/non-sharing state can be set without changing the data structure, and a more flexible system can be built.

In the above description, the command process and receiver process share a single receiver queue. Also, a plurality of receiver queues may be used. In this case, events held in all the receiver queues are checked in step S701 in the update process, and processes are executed for all events in step S702 and subsequent steps.

### Second Embodiment

In the system according to the first embodiment, a command is generated by the user or a program during its operation. In a system according to this embodiment, a command is further generated based on the contents described in a file. The system according to this embodiment will be described below. Note that this embodiment is substantially the same as the first embodiment except for the following contents.

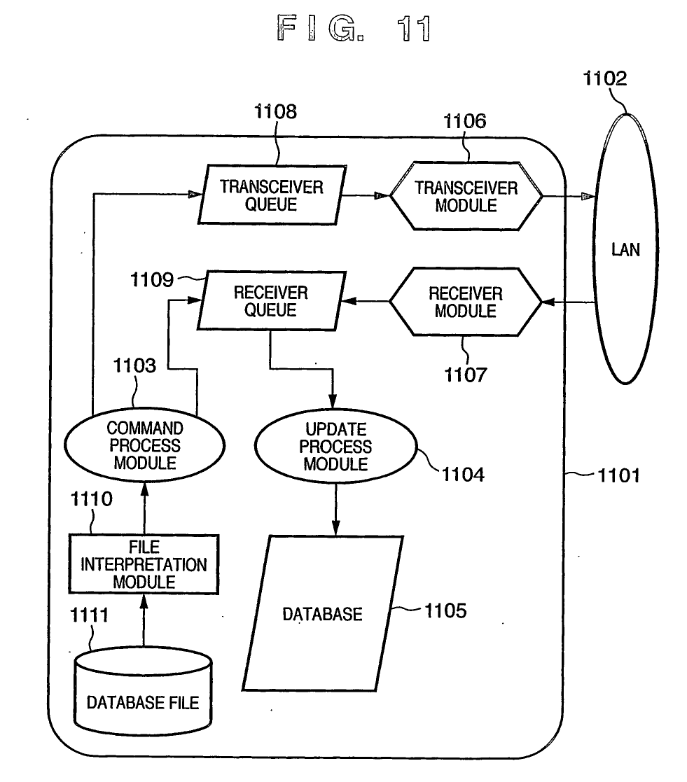

FIG. 11 is a diagram of processes implemented in the client terminal according to this embodiment. Arrows indicate the flow of data. In FIG. 11, components 1101 to 1109 are the same as the components 401 to 409 in FIG. 4.

Reference numeral 1111 denotes a database file, which describes the structure and properties of a virtual space, and is stored in the external storage device 306. Reference numeral 1110 denotes a file interpretation module, which interprets the contents of the database file 1111 and generates a manipulation command sequence to build a database 1105.

The configuration of the database file to be loaded by the client terminal according to this embodiment will be described below.

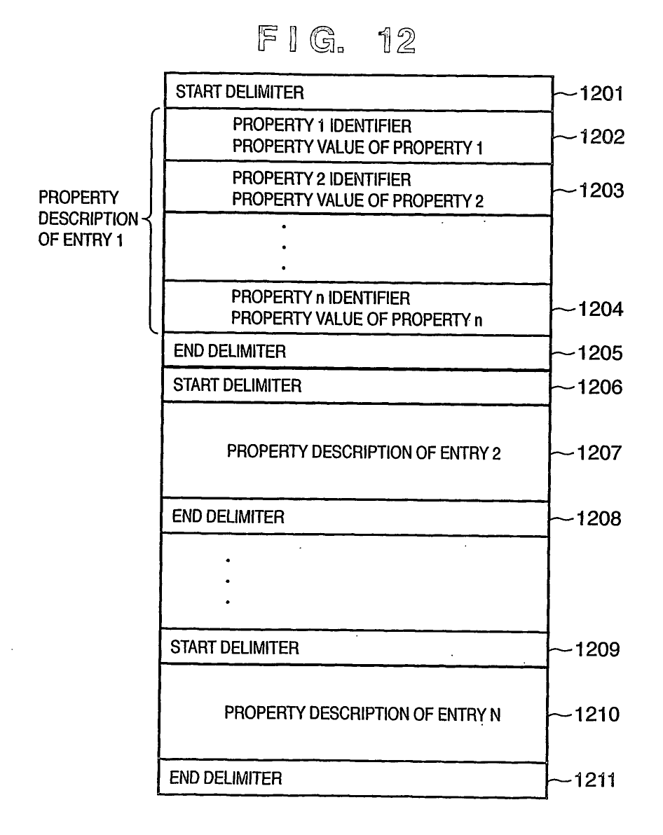

FIG. 12 shows the file format of data with N entries. The properties of each entry are described in fields bounded by start and end delimiters. In FIG. 12, the start delimiters of the first, second, and N-th entries are respectively denoted by 1201, 1206, and 1209. On the other hand, the end delimiters of these entries are 1205, 1208, and 1211.

Each property of an entry is described as a pair of an identifier used to identify that property, and an attribute value, as indicated by 1202 to 1204. These two properties need not always be described. If these properties are not described, they are set to be default values determined in advance by the system upon building the database.

With the above configuration, when a client terminal which is connected to the server apparatus loads such database file, manipulation commands for generating respective entries of the database and those for setting the properties of the respective entries are distributed to all the client terminals. The respective client terminals execute processes based on these manipulation commands to build identical databases. If the client terminal is not connected to the server apparatus, manipulation commands are processed in each client terminal that has loaded the database file, thus building the database.

Note that the type of file to be loaded by the client terminal is not limited to the aforementioned database file. For example, a file that describes manipulation contents for one or a plurality of databases may be interpreted by the file interpretation module to issue manipulation commands.

### Third Embodiment

In the first and second embodiments, the sharing mode is determined depending on whether or not the client terminal has established a communication path with the server apparatus. A system of this embodiment allows the user of the system to set the sharing mode. The system according to this embodiment will be described below. Note that this embodiment is substantially the same as the first embodiment except for the following contents.

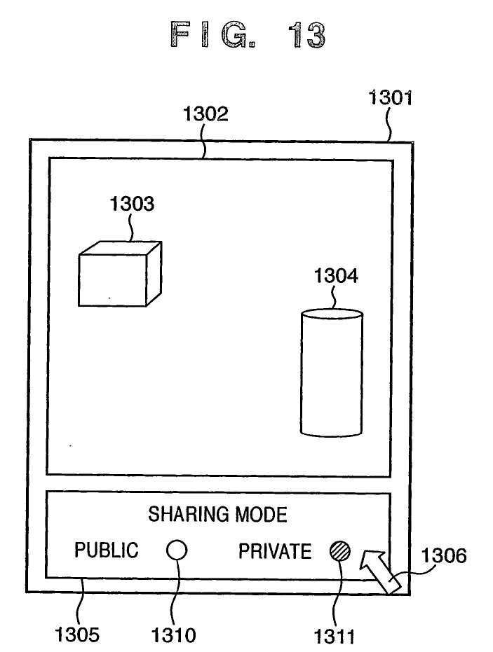

FIG. 13 shows an example of a window displayed on the display unit 309 of the client terminal. As in the first embodiment, since the contents of a database are data associated with the 3D virtual space, CG images of 3D virtual objects 1303 and 1304 according to the data associated with the 3D virtual space are displayed on a 3D space display area 1302 in a display window 1301.

A sharing mode setting area 1305 used to set a sharing mode is displayed below the 3D space display area 1302. On the sharing mode setting area 1305, radio buttons 1310 and 1311 corresponding to public and private modes are displayed. In order to set the sharing mode, the user moves a cursor 1306 to a radio button corresponding to a desired mode of those displayed on the sharing mode setting area 1305 (the radio button 1310 when the user wants to set a public mode; the radio button 1311 when he or she wants to set a private mode), and activates that button by clicking the left button of the mouse 308. Note that data indicating the set sharing mode is stored in the memory 302.

Note that this manipulation may be made using the keyboard 307, and the manipulation method is not particularly limited.

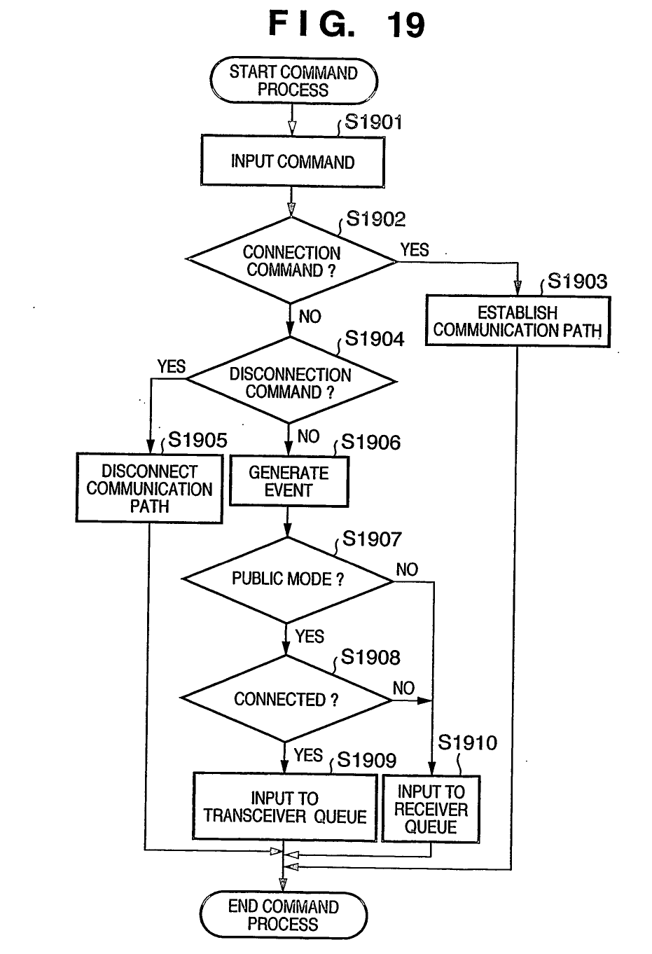

FIG. 19 is a flow chart of a command process according to this embodiment. An input command is detected (step S1901). Nest, the input command is interpreted to determine if this command is a command (connection command) that requests to establish a communication path with the server apparatus via the communication medium 102 (i.e., to connect the server apparatus via the communication medium 102) (step S1902). If the input command is a connection command, the flow advances to step S1903, and the communication unit 305 establishes a communication path with the server apparatus (step S1903), thus ending the command process.

On the other hand, if the input command is not a connection command, the flow advances to step S1904. In step S1904, the command input in step S1901 is interpreted to determine if this command is a command (disconnection command) that requests to disconnect the communication path with the server apparatus via the communication medium 102 (i.e., to disconnect from the server apparatus via the communication medium 102) (step S1904). If the input command is a disconnection command, the flow advances to step S1905, and the communication unit 305 disconnects the communication path with the server apparatus, thus ending the command process.

On the other hand, if the command input in step S1901 is not a disconnection command (i.e., it is neither a connection command nor a disconnection command), it is determined that this command is a database manipulation command, and the flow advances to step S1906. In step S1906, data called an event which indicates the contents of the manipulation command is generated (step S1906).

Next, it is checked with reference data of the sharing mode held in the memory 302 if the sharing mode is a public or private mode (step S1907). If the sharing mode is a public mode, the flow advances to step S1908 to check if the communication path has been established (step S1908).

If the communication path has been established, the flow advances to step S1909 to input the event generated in step S1906 to the transceiver queue assured on the memory 302 (step S1909), thus ending the command process.

On the other hand, if it is determined in step S1907 that the sharing mode is a private mode, or if it is determined in step S1908 that the communication path is not established, the flow advances to step S1910 to input the event generated in step S1906 to the receiver queue assured on the memory 302 (step S1910), thus ending the command process.

With the above process, the user can desirably and interactively set the sharing/non-sharing state of data at an arbitrary timing.

Note that the setting method of the sharing mode is not limited to such interactive manipulation. For example, the sharing mode may be determined based on an arbitrary algorithm by executing a program, and the determined sharing mode may be set.

### Fourth Embodiment

In the first to third embodiments, the sharing mode is likely to be changed during the operation of the program. Alternatively, an arrangement that does not change the sharing mode is also available. In this case, the setting value of the sharing mode is designated as a startup parameter upon, e.g., launching a program.

### Fifth Embodiment

In the system according to the first to fourth embodiments, the sharing mode is determined for each terminal. A system according to this embodiment has an arrangement that can set the sharing mode for respective data items included in a database. The system according to this embodiment will be described below. Note that this embodiment is substantially the same as the third embodiment except for the following contents. Also, data items correspond to virtual objects. However, the type of data item is not limited to this, and data with arbitrary contents or types may be used.

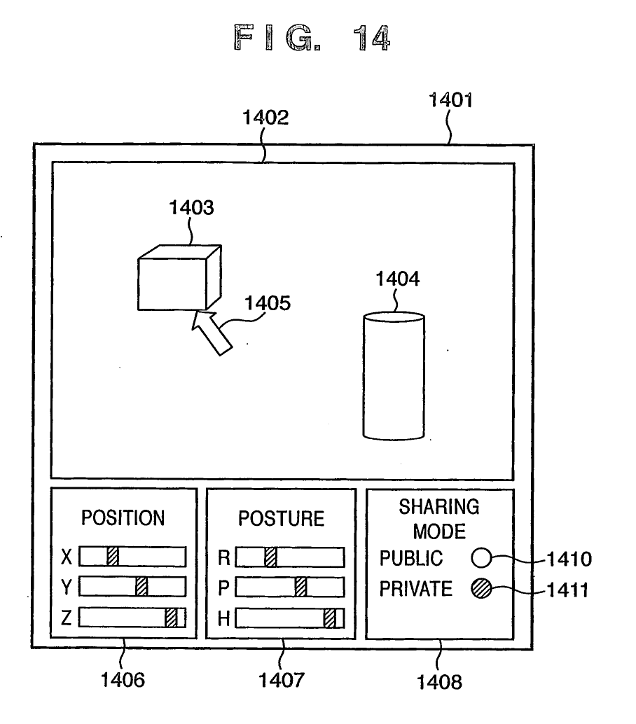

FIG. 14 shows an example of a window displayed on the display unit 309 of the client terminal. As in the first embodiment, since the contents of a database are data associated with the 3D virtual space, CG images of 3D virtual objects 1403 and 1404 according to the data associated with the 3D virtual space are displayed on a 3D space display area 1402 in a display window 1401.

Also, a position setting area 1406, orientation setting area 1407, and sharing mode setting area 1408, which are used to set the position and orientation and sharing mode of each 3D virtual object displayed on the 3D space display area 1402 are displayed below the 3D space display area 1402.

On the sharing mode setting area 1408, a radio button 1410 used to set a public mode as the sharing mode, and a radio button 1411 used to set a private mode are displayed. A sharing mode setting process for each virtual object displayed on the 3D space display area 1402 will be explained below taking the virtual object 1403 as an example.

The user moves a cursor 1405 onto the virtual object 1403 by manipulating the mouse 308, and selects that virtual object 1403 by clicking the left button of the mouse. The user then activates a radio button corresponding to a desired mode of those displayed on the sharing mode setting area 1408 (the radio button 1410 when the user wants to set a public mode; the radio button 1411 when he or she wants to set a private mode) by clicking the left button of the mouse 308.

In this manner, the user can set a desired mode for a desired virtual object (the virtual object 1403 in this case). Note that data indicating the sharing mode set for the virtual object 1403 is stored in the memory 302.

When the user repeats such manipulation for the virtual object 1404, he or she can also set a desired mode for the virtual object 1404. That is, the user can individually set sharing modes for respective virtual objects. In this case, data indicating sharing modes set for the respective virtual objects are stored in the memory 302.

Note that sliders are displayed on the position setting area 1406 and orientation setting area 1407, and the user can interactively change the position and orientation of the selected virtual object by manipulating them.

Note that this manipulation may be made using the keyboard 307, and the manipulation method is not particularly limited.

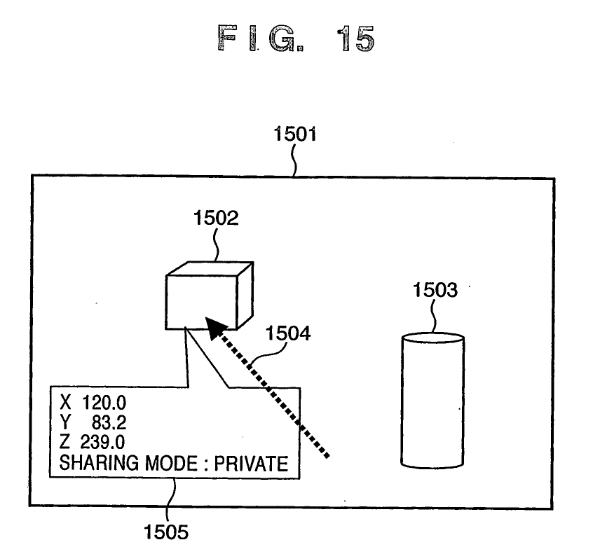

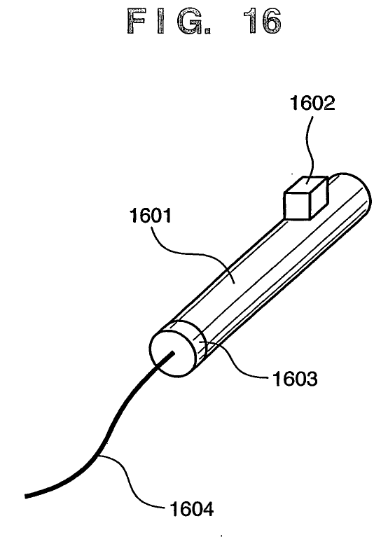

FIG. 15 shows another display example. A window shown in FIG. 15 is also displayed on the display unit 309 of the client terminal. In this case, the user wears an HMD (Head Mounted Display) on his or her head, and observes a 3D display window 1501 of a virtual space, as shown in FIG. 15, which is displayed on a display unit of the HMD. On the window, reference numerals 1502 and 1503 denote virtual objects; and 1504, a pointer used to select/manipulate an object. The user holds a stylus device 1601 shown in FIG. 16 with his or her hand, and controls the position and orientation of the pointer 1504 by moving it.

In such arrangement, in order to set or change the sharing mode for each virtual object, the user moves the stylus device 1601 so that the pointer 1504 points up a virtual object image whose mode is to be changed, and presses a select button 1602 to select that object. At this time, an annotation window 1505 that shows the properties of the selected object appears on the window that the user observes. The annotation window 1505 also shows the currently selected sharing mode.

Next, the user turns a dial 1603 provided to the end portion of the stylus device. Since the sharing mode displayed on the annotation window 1505 alternates private and public modes upon turning, the user stops turning the dial when a desired mode is displayed. In this way, the sharing mode of user's choice can be set by his or her interactive manipulation.

Note that the HMD corresponds to the display unit (309 in FIG. 3), and is connected to the client terminal. The stylus device is connected to the client terminal via the input/output unit (310 in FIG. 3) and a data transceiver cable 1604, and the CPU 301 reads out the selection state of the position/orientation select button 1602 and the turning state of the dial 1603.

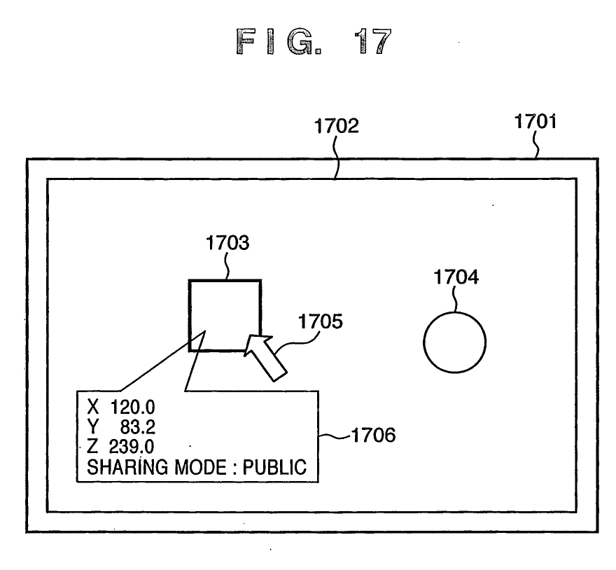

In place of the 3D display of the virtual space shown in FIGS. 14 and 15, a two-dimensional (2D) display may be used. FIG. 17 shows an example of such 2D display. In the example shown in FIG. 17, a 2D display area 1702 on a display window 1701 displays a 2D observation state of a 3D space from a given direction. Virtual objects 1703 and 1704 are displayed as icons on the 2D display area 1702. When the user sets a cursor 1705 on a desired icon and clicks the left button of the mouse 308, he or she can select that object. Upon setting the sharing mode, after the user selects the object, he or she presses a predetermined key of the keyboard 307.

In this way, the sharing mode of user's choice can be set by his or her interactive manipulation. Note that an annotation window 1706 that shows the properties of the selected object may be displayed on the window upon selecting the object. When the annotation window 1706 also shows the currently selected sharing mode, the user can set the sharing mode while confirming the current mode.

In any of the above cases, a manipulation event for manipulating each data item is output to one of the receiver queue and transceiver queue in correspondence with the sharing mode set for that data item.

Also, in any of the above cases, a manipulation method is not limited to that in the above description as in the first to third embodiments.

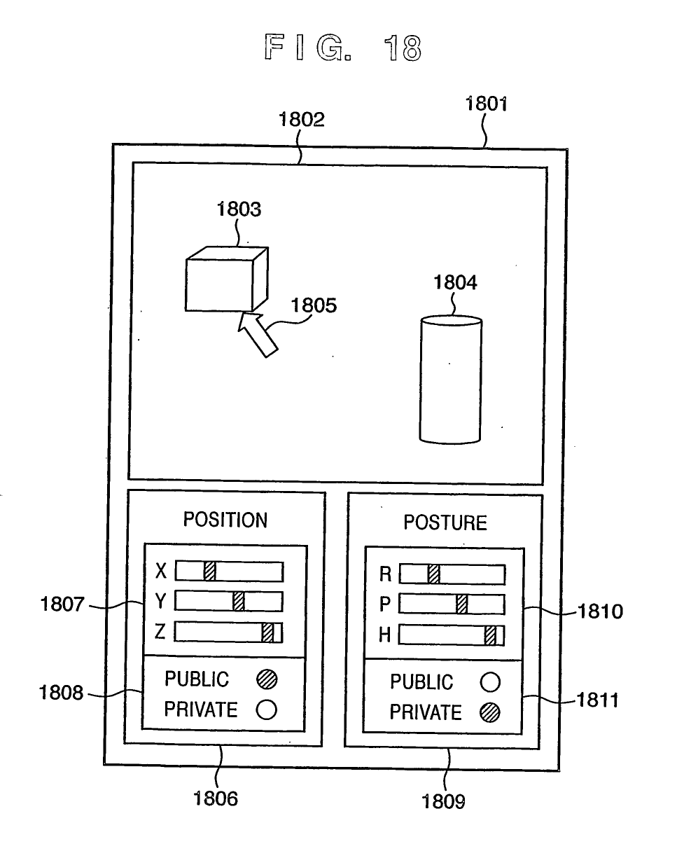

In the above example, the sharing mode is set for each database item. A case will be explained below wherein the sharing mode is set for each property of an item. FIG. 18 shows an example of a window display used to set the sharing mode for each property of an item. The window shown in FIG. 18 is displayed on the display unit 309 of the client terminal. In this case, data of the position and orientation of each virtual object correspond to properties of a data item. However, the types of properties of a data item are not limited to these specific types, and data with arbitrary contents or types may be used.

Components 1801 to 1805 are the same as the components 1401 to 1405. A position property setting area 1806 used to set the position and its sharing mode of a virtual object, and a orientation property setting area 1807 used to set the orientation and its sharing mode of a virtual object are displayed below a 3D display area 1802.

The position property setting area 1806 includes a position setting field 1807 used to set the position, and a position sharing mode setting field 1808 used to set the sharing mode associated with the position.

The orientation property setting area includes a orientation setting field 1810 used to set the orientation, and a orientation sharing mode setting field 1811 used to set the sharing mode associated with the orientation.

The process in the arrangement that sets the sharing mode for each database item or each property of an item is the same as that in the third embodiment. However, a management method of the setting values of the sharing mode in this embodiment is different from the third embodiment. That is, in the third embodiment, the setting value of the sharing mode is held in each terminal. However, when the sharing mode is determined for each database item or each property of an item as in this embodiment, the setting value of the sharing mode is held for each item or each property of an item.

Therefore, according to this embodiment, the user can interactively set the sharing mode for each data item or each property of an item at an arbitrary timing.

Note that the setting method of the sharing mode is not limited to such interactive manipulation. For example, the sharing mode may be determined based on an arbitrary algorithm by executing a program, and the determined sharing mode may be set.

### Sixth Embodiment

The fifth embodiment has explained the arrangement for interactively setting the sharing mode using a GUI. Alternatively, the sharing mode may be set to be a mode designated in advance. The mode is described in, e.g., a database file. When the sharing mode is designated for each database item, a pair of “sharing mode identifier” and “setting value of sharing mode” is described as one of property values of an item. When the sharing mode is set for each property of an item, a setting value of the sharing mode is described in addition to the pair of “property identifier” and “property value”.

Therefore, according to this embodiment, the sharing/non-sharing data of data can be determined in accordance with the sharing mode, which is set in advance for each database item or each property of an item.

### Seventh Embodiment

A system according to this embodiment aims at solving the following problem. That is, when an arbitrary computer terminal changes shared data before all computer terminals that share a virtual space establish connection to a network, a computer terminal which is not connected to the network cannot receive information associated with that change, and data inconsistency occurs among programs which run on the respective terminals.

The system according to this embodiment comprises an arrangement that can reliably reflect, on a predetermined number of client terminals, the contents of a scene graph database manipulation (which means a manipulation of data to be shared among the client terminals in this embodiment) which is made at an arbitrary client terminal.

The system according to this embodiment will be described below. Note that this embodiment is substantially the same as the first embodiment except for the following contents.

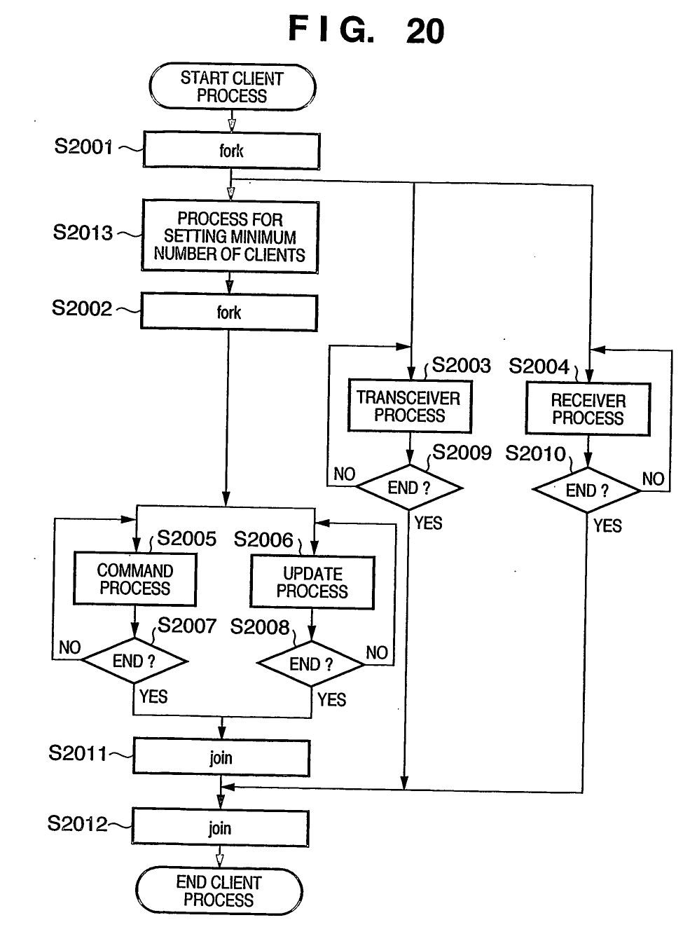

FIG. 20 is a flow chart of a main process to be executed by the client terminal. Note that a program according to the flow chart of FIG. 20 is saved in the external storage device 306, is loaded onto the memory 302 as needed, and is executed by the CPU 301. As a result, the client terminal can implement the process according to the flow chart of FIG. 20.

Since steps S2001 to S2004 and S2007 to S2012 are the same as steps S501 to S504 and S507 to S512 in FIG. 5, a description thereof will be omitted. Hence, the difference between the process to be executed by the client terminal according to this embodiment and that to be executed by the client terminal according to the first embodiment lies in a process executed in step S2013. Also, as for step S2005, the process to be described later is executed in place of that in step S505. Also, as for step S2006, the process to be described later is executed in place of that in step S506. Therefore, the processes in these steps S2005, S2006, and S2013 will be explained below.

In step S2013, a minimum number of client terminals which are to share the virtual space is set. Note that all client terminals use an identical value as the minimum number of client terminals to be set in this step. As this setting method, data indicating the minimum number of client terminals may be held in advance in the external storage device 306, or data indicating the minimum number of client terminals may be held in advance in the server apparatus, and when each client terminal establishes a communication path with the server apparatus, it may download that data onto its memory 302. Also, the user may designate the minimum number of client terminals upon starting the operation of the client terminal.

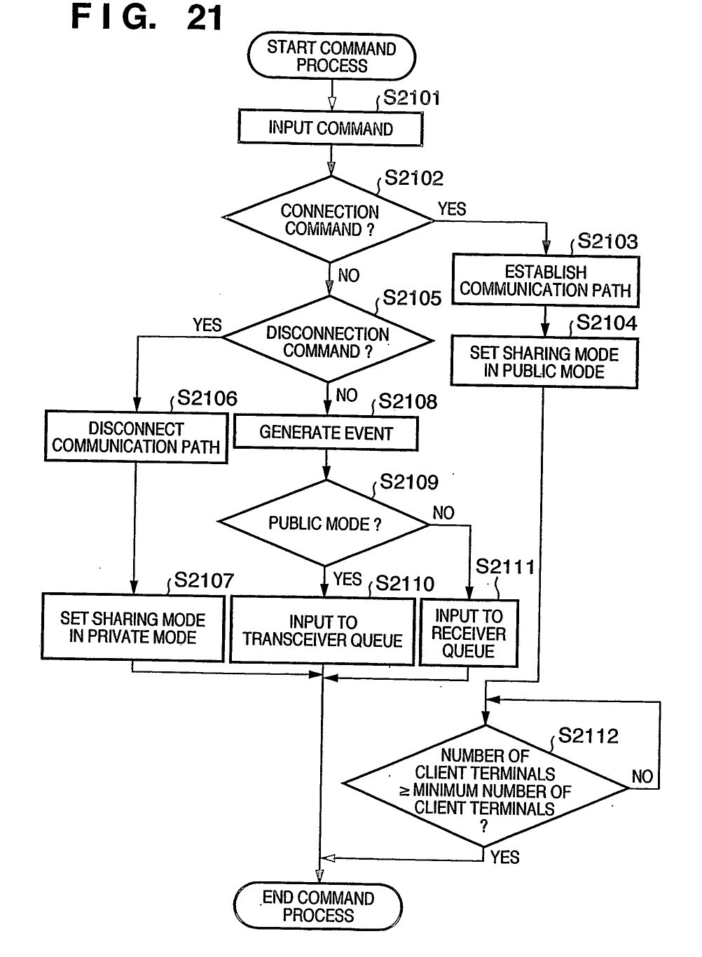

FIG. 21 is a flow chart of a process as the first example of the command process in step S2005 according to this embodiment. In the process of the first example, a process for reliably notifying a predetermined number of client terminals of the contents of a manipulation to the scene graph database is added to the command process according to the first embodiment (the process according to the flow chart shown in FIG. 6).

Steps S2101 to S2111 are respectively the same as steps S601 to S611 in FIG. 6. It is checked in step S2112 if “the number of connected client terminals” acquired by a process to be described later is equal to or larger than “the minimum number of client terminals” held in the memory 302. If YES in step S2112, the command process ends.

On the other hand, if NO in step S2112, the flow returns to step S2112.

As a result, a subsequent command is delayed until the number of client terminals which are connected to the server apparatus reaches a predetermined value. In the first example of the command process, the number of client terminals is checked after the sharing mode setting process in step S2104. Instead, the same process as in step S2112 may be executed immediately before step S2108, and if the checking result is YES, the flow may advance to step S2108; if the checking result is NO, the same process as in step S2112 may be repeated.

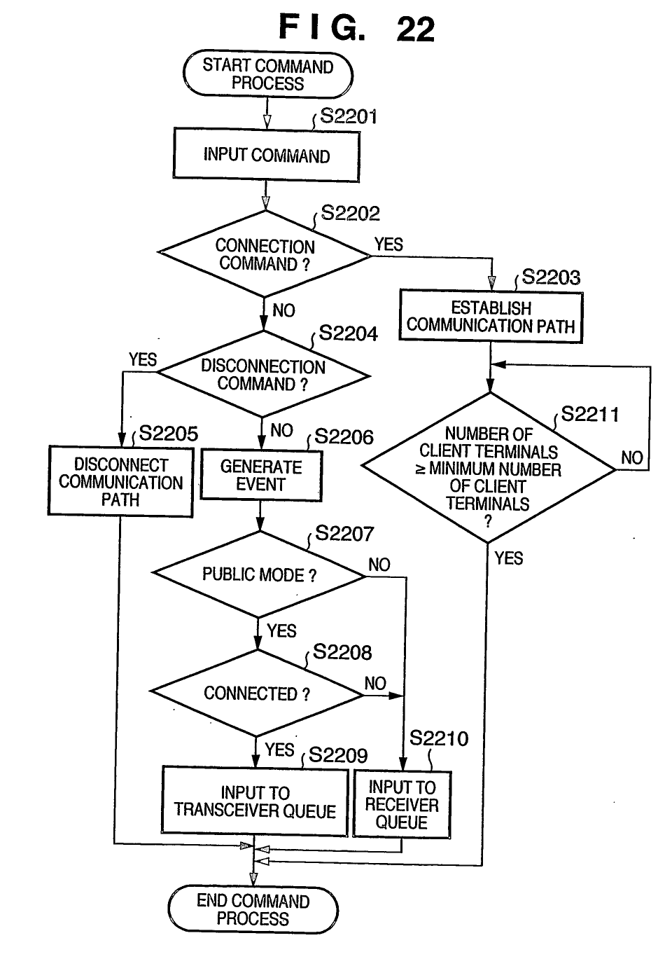

On the other hand, FIG. 22 is a flow chart of a process as the second example of the command process in step S2005. In the process of the second example, a process for reliably notifying a predetermined number of client terminals of the contents of a manipulation to the scene graph database is added to the command process according to the third to sixth embodiments.

Steps S2201 to S2210 are respectively the same as steps S1901 to S1910 in FIG. 19. It is checked in step S2211 if “the number of connected client terminals” acquired by a process to be described later is equal to or larger than “the minimum number of client terminals” held in the memory 302. If YES in step S2211, the command process ends.

On the other hand, if NO in step S2211, the flow returns to step S2211. As a result, a subsequent command is delayed until the number of client terminals which are connected to the server apparatus reaches a predetermined value. In the second example of the command process, the number of client terminals is checked after the communication path establishment process in step S2203. Instead, the same process as in step S2211 may be executed immediately before step S2206, and if the checking result is YES, the flow may advance to step S2206; if the checking result is NO, the same process as in step S2211 may be repeated.

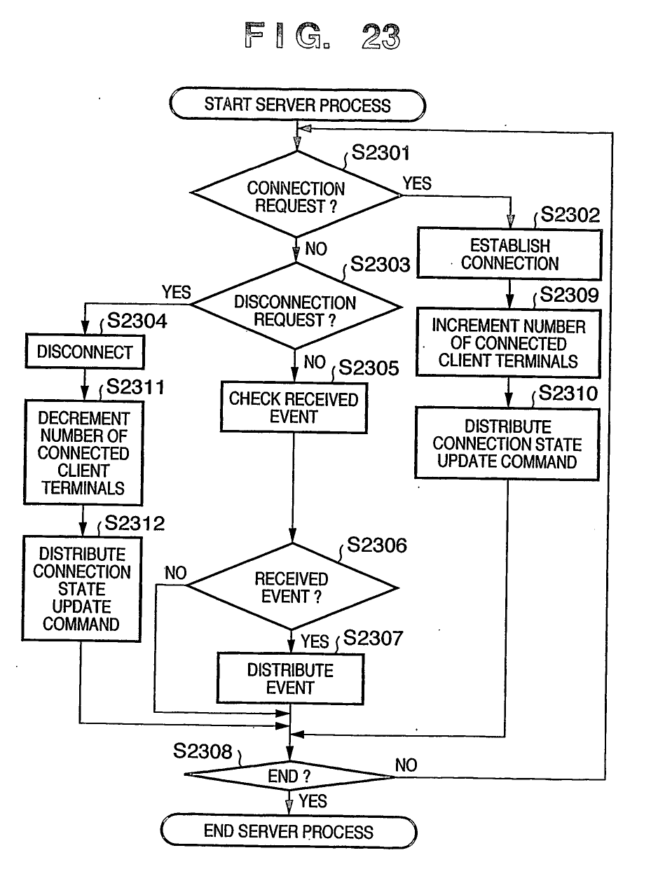

FIG. 23 is a flow chart of a main process to be executed by the server apparatus according to this embodiment. Steps S2301 to S2308 are respectively the same as steps S1001 to S1008 in FIG. 10. Hence, the difference between the process to be executed by the server apparatus according to this embodiment and that to be executed by the server apparatus according to the first embodiment lies in processes executed in steps S2309 to S2312. Therefore, the processes in steps S2309 to S2312 will be explained below. Note that the server apparatus holds “the number of connected client terminals” as that of client terminals, which are connected to it. Assume that the number of connected client terminals is reset to zero when each client terminal starts up.

In step S2309, the number of connected client terminals is incremented by one. In step S2310, the number of connected client terminals is distributed to all the client terminals together with information (connection state update command) that instructs to update the number of connected client terminals. On the other hand, the number of connected client terminals is decremented by one in step S2311. In step S2312, the number of connected client terminals is distributed to all the client terminals together with information (connection state update command) that instructs to update the number of connected client terminals.

More specifically, when the server according to this embodiment establishes a communication path with a new client terminal, it informs all the client terminals of the number of client terminals which are connected to the server apparatus. Also, when the server apparatus disconnects the already established communication path with a given client terminal, it informs all the client terminals of the number of client terminals which are connected to the server apparatus.

When the server apparatus transmits the connection state update command to all the client terminals in step S2309 or S2312, each of all the client terminals that received this command sets the number of connected client terminals received together with the connection state update command in a variable (held in the memory 302) which indicates the number of client terminals connected to the server apparatus, in step S2006.

In this manner, all the client terminals can always recognize the number of client terminals connected to the server apparatus.

As described above, according to the system of this embodiment, when an arbitrary client terminal makes a scene graph database manipulation to manipulate data to be shared, a minimum number of client terminals can be reliably notified of the manipulation contents.

That is, when the number of client terminals which have established a communication path with the server apparatus is smaller than the minimum number of client terminals, the manipulation contents are not distributed. Hence, system inconsistency (e.g., only some client terminals manipulate the scene graph databases according to the manipulation contents) can be avoided.

In this embodiment, an event as data of the contents (i.e., a command) of a manipulation of the scene graph databases is transmitted to other client terminals. Alternatively, various data may be transmitted in place of an event.

### Eighth Embodiment

In the seventh embodiment, the client terminals and server apparatus delay execution of a process for notifying of an event as data indicating the contents of a scene graph database manipulation among client terminals, until a predetermined number of client terminals establish a communication path with the server apparatus. A system according to this embodiment allows each client terminal to execute another process without waiting it.

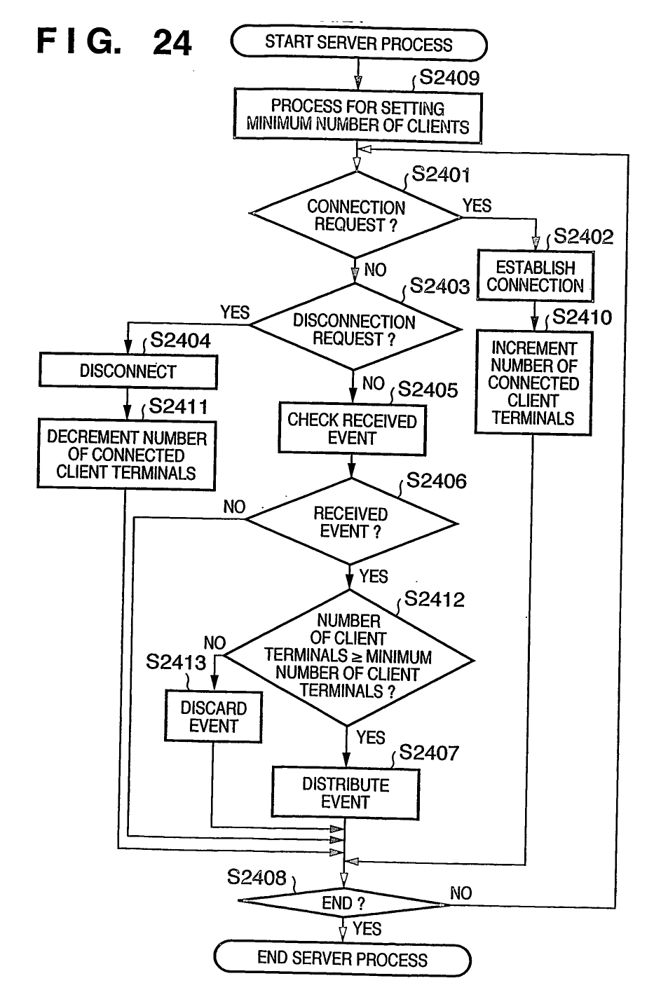

FIG. 24 is a flow chart of a main process to be executed by the server apparatus according to this embodiment. Steps S2401 to S2408 are respectively the same as steps S1001 to S1008 in FIG. 10. Also, steps S2410 and S2411 are respectively the same as steps S2309 and S2311.

In step S2409, a minimum number of client terminals which are to share the virtual space is set. As this setting method, data indicating the minimum number of client terminals may be held in advance in the external storage device 306.

In step S2410, a variable (held in the memory 302) indicating the number of client terminals is incremented by one since connection to a new client terminal has been established in step S2402.

In step S2411, a variable (held in the memory 302) indicating the number of client terminals is decremented by one since connection to a given client terminal is disconnected in step S2404.

In this way, the server apparatus counts the number of client terminals with which the communication path has been established. Note that the value of this variable is reset to zero upon starting up the server apparatus.

It is checked in step S2412 if “the number of client terminals connected to the server apparatus”: is equal to or larger than “the minimum number of client terminals” held in the memory 302. If YES in step S2412, the flow advances to step S2407. On the other hand, if NO in step S2412, the flow advances to step S2413 to discard the received event. After that, the flow advances to step S2408.

As described above, according to the system of this embodiment, even when the number of client terminals which have established the communication path with the server apparatus is smaller than the minimum number of client terminals, each client terminal can execute a process other than the process for transmitting an event stored in the transceiver queue to the server apparatus. In the seventh embodiment, each client terminal delays execution of the process in such case. Hence, a system with higher operation efficiency than that of the seventh embodiment can be built.

Even when the process for transmitting an event stored in the transceiver queue is executed, the server discards the received event until a predetermined number of client terminals establish connection to the server apparatus. Hence, data inconsistency among client terminals due to a distribution error of an event to some client terminals which are not connected to the server can be avoided.

### Ninth Embodiment

The system according to the first to eighth embodiments adopts a server-client arrangement. However, the present invention is not limited to such specific arrangement. For example, when each client terminal plays a role of client, and also has a function of a server (a reception function of connection and disconnection requests, and a data distribution function to clients), the same effects as in the above embodiments can be obtained in an arrangement in which each client terminal is connected to all other client terminals.

### 10th Embodiment

In the first to ninth embodiments, data to be shared is scene data which represents the structure and properties of the virtual space. However, the present invention is not limited to such specific data, and various other data may be used as data to be shared.

Note that the objects of the present invention are also achieved by supplying a storage medium, which records a program code of a software program that can implement the functions of the above-mentioned embodiments to a system or apparatus, and reading out and executing the program code stored in the storage medium by a computer (or a CPU or MPU) of the system or apparatus.

In this case, the program code itself read out from the storage medium implements the functions of the above-mentioned embodiments, and the storage medium which stores the program code constitutes the present invention. One or a plurality of server programs as programs having functions of the aforementioned server apparatus and client programs as programs having functions of the client terminal can run on a single terminal. When a plurality of programs run on a single terminal, the server and client programs can be arbitrarily combined.

As the storage medium for supplying the program code, for example, a flexible disk, hard disk, optical disk, magneto-optical disk, CD-ROM, CD-R, magnetic tape, nonvolatile memory card, ROM, and the like may be used.

The functions of the above-mentioned embodiments may be implemented not only by executing the readout program code by the computer but also by some or all of actual processing operations executed by an OS (operating system) running on the computer on the basis of an instruction of the program code. Note that the aforementioned program code may be executed as a process managed by the OS or in a thread of the process.

Furthermore, the functions of the above-mentioned embodiments may be implemented by some or all of actual processing operations executed by a CPU or the like arranged in a function extension board or a function extension unit, which is inserted in or connected to the computer, after the program code read out from the storage medium is written in a memory of the extension board or unit.

As described above, the present invention can provide a technique that makes a data sharing system to be a flexible and flexible and consistent system.

Especially, the sharing/non-sharing state can be switched without changing the data structure.

Also, the sharing/non-sharing state can be switched not only for each item of data but also for each program or each property of a data.

Upon connecting a communication path, since all client terminals equally receive change information of shared data, data consistency (identity) among client terminals can be assured.

The present invention is not limited to the above embodiments and various changes and modifications can be made within the spirit and scope of the present invention.

Therefore, to apprise the public of the scope of the present invention, the following claims

1. An information processing method to be executed by an information processing apparatus which can communicate with a self apparatus and other apparatuses via a server apparatus, and comprises first holding unit adapted to hold data indicating contents of command transmitted from the information processing apparatus to the server apparatus, and second holding unit adapted to hold data indicating contents of a command to be processed in the self apparatus, characterized by comprising:
an interpretation step of interpreting an input command;
a control step of establishing or disconnecting, when it is determined as a result of interpretation in the interpretation step that the input command is a command that requests to establish or disconnect a communication path with the server apparatus, the communication path in accordance with the input command; and
an output step of generating, when it is determined as a result of interpretation in the interpretation step that the input command is a command that requests to manipulate a predetermined database, data indicating the input command, and outputting the generated data to one of the first and second holding units depending on whether the communication path is established or disconnected in the control step.

2. The method according to claim 1, characterized by further comprising a transmission step of transmitting, when the communication path is established, data held in the first holding unit to the server apparatus.

3. The method according to claim 2, characterized in that the data transmitted to the server apparatus in the transmission step is transmitted to the self apparatus and the other apparatuses via the server apparatus.

4. The method according to claim 2, characterized in that the transmission step includes a step of transmitting, when it is determined using information used to obtain the number of apparatuses that have established the communication path with the server apparatus that the number of apparatuses that have established the communication paths with the server apparatus is not less than a predetermined value, the data held in the first holding unit to the server apparatus.

5. The method according to claim 1, characterized by further comprising a processing step of manipulating the database in accordance with a command indicated by the data held in the second holding unit.

6. The method according to claim 1, characterized in that the control step includes a step of setting a mode for determining to which of the first and second holding units the generated data is output in the output step, in accordance with whether the communication path is established or disconnected.

7. The method according to claim 6, characterized in that the mode is set in a first mode when the communication path is established, or in a second mode when the communication path is disconnected, and
the output step includes a step of outputting, when the mode is set in the first mode, the generated data to the first holding unit, and outputting, when the mode is set in the second mode, the generated data to the second holding unit.

8. The method according to claim 1, characterized in that the control step includes a step of setting a mode for determining to which of the first and second holding units the generated data is output in the output step, in accordance with an external instruction.

9. The method according to claim 8, characterized in that the mode is set in one of first and second modes in accordance with the external instruction, and
the output step includes a step of outputting, when the mode is set in the first mode and the communication path is established, the generated data to the first holding unit, and outputting, when the mode is set in the second mode or when the mode is set in the first mode and the communication path is disconnected, the generated data to the second holding unit.

10. An information processing method having a first mode for outputting information to other processes with which communications can be made, and a second mode for outputting information to a self process, characterized by comprising:
a generation step of generating manipulation request information indicating a manipulation request to data;
a transmission step of inputting the generated request information to a transceiver queue, and transmitting the request information to the other processes;
a reception step of receiving manipulation request information generated by the other processes, and inputting the received request information to a receiver queue; and
a manipulation execution step of executing a data manipulation in accordance with the manipulation request information input to the receiver queue, and
in that when the first mode is set, the manipulation request information generated in the generation step is input to the transceiver queue and is transmitted to the other processes in the transmission step, and
when the second mode is set, the manipulation request information generated in the generation step is input to the receiver queue, and a data manipulation is executed in the manipulation execution step in accordance with the manipulation request information input to the receiver queue.

11. The method according to claim 10, characterized in that the first mode is a sharing mode in which data is to be shared, and the second mode is a non-sharing mode in which data is not to be shared.

12. The method according to claim 10, characterized in that the data comprises information of a database item.

13. The method according to claim 10, characterized in that the data comprises information of a property of a database item.

14-15. (canceled)

16. An information processing apparatus which can communicate with a self apparatus and other apparatuses via a server apparatus, characterized by comprising:
first holding unit adapted to hold data indicating contents of a command transmitted from the information processing apparatus to the server apparatus;
second holding unit adapted to hold data indicating contents of a command to be processed in the self apparatus;
interpretation unit adapted to interpret an input command;
control unit adapted to, when it is determined as a result of interpretation by said interpretation unit that the input command is a command that requests to establish or disconnect a communication path with the server apparatus, establish or disconnect the communication path in accordance with the input command; and
output unit adapted to, when it is determined as a result of interpretation by said interpretation unit that the input command is a command that requests to manipulate a predetermined database, generate data indicating the input command, and output the generated data to one of said first and second holding units depending on whether the communication path is established or disconnected by said control unit.

17. An information processing apparatus having a first mode for outputting information to other processes with which communications can be made, and a second mode for outputting information to a self process, characterized by comprising:
generation unit adapted to generate manipulation request information indicating a manipulation request to data;
transceiver unit adapted to input the generated request information to a transceiver queue, and transmit the request information to the other processes;
receiver unit adapted to receive manipulation request information generated by the other processes, and input the received request information to a receiver queue; and
manipulation execution unit adapted to execute a data manipulation in accordance with the manipulation request information input to the receiver queue, and
in that when the first mode is set, said transceiver unit inputs the manipulation request information generated by said generation unit to the transceiver queue and transmits the request information to the other processes, and
when the second mode is set, the manipulation request information generated by said generation unit is input to the receiver queue, and said manipulation execution unit executes a data manipulation in accordance with the manipulation request information input to the receiver queue.

18. (canceled)

19. A program characterized by making a computer, which can communicate with a self apparatus and apparatuses via a server apparatus, and comprises first holding unit adapted to hold data indicating contents of a command transmitted from the information processing apparatus to the server apparatus, and second holding unit adapted to hold data indicating contents of a command to be processed in the self apparatus, execute an information processing method of claim 1.

20. A program characterized by making a computer, which can communicate with a self apparatus and other apparatuses via a server apparatus, and comprises first holding unit adapted to hold data indicating contents of a command transmitted from the information processing apparatus to the server apparatus, and second holding unit adapted to hold data indicating contents of a command to be processed in the self apparatus, execute an information processing method of claim 10.

21. (canceled)
